(19) United States
(12) Patent Application Publication
(10) Pub. No.: US 2024/0289646 A1
(43) Pub. Date: Aug. 29, 2024

(54) INFORMATION PROCESSING DEVICE, LEARNING METHOD, AND NON-TRANSITORY RECORDING MEDIUM

(71) Applicant: NEC Corporation, Minato-ku, Tokyo (JP)

(72) Inventors: Yoichi SASAKI, Tokyo (JP); Yuzuru OKAJIMA, Tokyo (JP)

(73) Assignee: NEC Corporation, Minato-ku, Tokyo (JP)

(21) Appl. No.: 18/566,261

(22) PCT Filed: Jun. 7, 2021
(86) PCT No.: PCT/JP2021/021561

§ 371 Date: Dec. 1, 2023

(51) Int. Cl. G06N 5/022

(52) U.S. Cl. CPC G06N 5/022

(57) ABSTRACT

In order to improve prediction performance in prediction carried out with use of a decision list, an information processing apparatus (1) includes: a prediction section (11) that calculates a prediction result with use of predicted values of, among decision rules included in the decision list, K (K is a natural number of not less than 2) top-ranked decision rules whose conditions are satisfied by one of training examples included in a training example set; and a list determining section (12) that determines, on the basis of the prediction result given by the prediction section (11), a decision list to be output.

### TECHNICAL FIELD

The present invention relates to, for example, an information processing apparatus that outputs a decision list by machine learning.

### BACKGROUND ART

Prediction by artificial intelligence (AI) involving use of black box models such as a deep neural network and a random forest has such a disadvantage that it is impossible to explain ground for the prediction.

For this reason, a prediction model called a decision list has attracted attention again as one of pieces of AI that makes it possible explain ground for prediction. A decision list is a list composed of a plurality of if-then rules, as disclosed in Non-patent Literature 1 below. In prediction involving use of a decision list, a rule that is among rules whose conditions (“if” of an if-then rule) are satisfied by observation and that is located at the topmost of the decision list is applied to carry out the prediction. Consequently, a prediction result can be explained with a single rule. Further, it is easy for a human to understand how the rule has been selected. A decision list thus has an advantage of making it possible to explain ground for prediction.

### CITATION LIST

### Non-Patent Literature

[Non-patent Literature 1]

Cynthia Rudin, Seyda Ertekin, “Learning customized and optimized lists of rules with mathematical programming”, Math. Program. Comput., 2018

### SUMMARY OF INVENTION

### Technical Problem

The technique of Non-patent Literature 1, however, has a problem of being inferior in prediction performance to black box models such as a deep neural network and a random forest. An example object of an example aspect of the present invention is to provide, for example, an information processing apparatus that can improve prediction performance in prediction carried out with use of a decision list.

### Solution to Problem

An information processing apparatus in accordance with an example aspect of the present invention includes: a prediction means that calculates a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and a list determining means that determines, from among a plurality of the decision lists generated from the decision rule set, a decision list to be output, the determining being made on a basis of a prediction result calculated for the training examples included in the training example set.

An information processing apparatus in accordance with an example aspect of the present invention includes: an input data acquiring means that acquires input data to be subjected to prediction; and a prediction means that calculates a prediction result with use of predicted values of, among decision rules included in a decision list composed of the decision rules each of which is a combination of a condition and a predicted value for a case where the condition is satisfied, K (K is a natural number of not less than 2) top-ranked decision rules whose conditions are satisfied by the input data.

A learning method in accordance with an example aspect of the present invention includes: (a) calculating a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and (b) determining, from among a plurality of the decision lists generated from the decision rule set, a decision list to be output, the determining being made on a basis of a prediction result calculated for the training examples included in the training example set, (a) and (b) being carried out by at least one processor.

A learning program in accordance with an example aspect of the present invention for causing a computer to function as: a prediction means that calculates a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and a list determining means that determines, from among a plurality of the decision lists generated from the decision rule set, a decision list to be output, the determining being made on a basis of a prediction result calculated for the training examples included in the training example set.

### Advantageous Effects of Invention

In accordance with an example object of an example aspect of the present invention, it is possible to improve prediction performance in prediction carried out with use of a decision list.

### BRIEF DESCRIPTION OF DRAWINGS

FIG. 1 is a block diagram illustrating a configuration of an information processing apparatus according to a first example embodiment of the present invention.

FIG. 2 is a flowchart illustrating a flow of a learning method and a prediction method in accordance with the first example embodiment of the present invention.

FIG. 3 is a diagram illustrating an overview of a learning method according to a second example embodiment of the present invention.

FIG. 4 is a block diagram illustrating an example of a configuration of an information processing apparatus according to the second example embodiment of the present invention.

FIG. 5 is a flowchart illustrating a flow of a learning method executed by the information processing apparatus.

FIG. 6 is a diagram illustrating an overview of a learning method according to a third example embodiment of the present invention.

FIG. 7 is a block diagram illustrating an example of a configuration of an information processing apparatus according to the third example embodiment of the present invention.

FIG. 8 is a flowchart illustrating a flow of a learning method executed by the information processing apparatus.

FIG. 9 is a block diagram illustrating an example of a configuration of an information processing apparatus according to a fourth example embodiment of the present invention.

FIG. 10 is a block diagram illustrating a configuration of an information processing apparatus according to a reference example.

FIG. 11 is a drawing illustrating an example of a computer which executes instructions of a program that is software realizing functions of the information processing apparatuses according to the example embodiments and reference examples of the present invention.

### DESCRIPTION OF EMBODIMENTS

### First Example Embodiment

The following description will discuss a first example embodiment of the present invention in detail with reference to the drawings. The first example embodiment is an embodiment serving as a basis for example embodiments described later.

### (Configuration of Information Processing Apparatus 1)

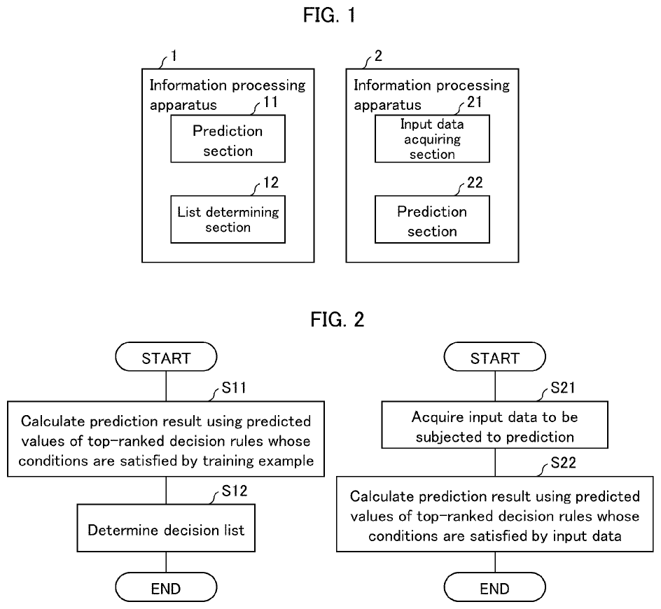

The following description will discuss, with reference to FIG. 1, a configuration of an information processing apparatus 1 according to the present example embodiment. FIG. 1 is a block diagram illustrating a configuration of the information processing apparatus 1 and an information processing apparatus 2. Note that the information processing apparatus 2 will be described later. The information processing apparatus 1 includes a prediction section (prediction means) 11 and a list determining section (list determining means) 12 as illustrated in FIG. 1.

The prediction section 11 calculates a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set.

The list determining section 12 determines, from among the decision lists generated from the decision rule set, a decision list to be output, the determining being made on the basis of a prediction result calculated for the training examples included in the training example set.

As described above, a configuration is employed such that the information processing apparatus 1 according to the present example embodiment includes: the prediction section 11 that calculates a prediction result with use of predicted values of, among decision rules included in a decision list composed of the decision rules extracted from a decision rule set, K (K is a natural number of not less than 2) top-ranked decision rules whose conditions are satisfied by one of training examples included in a training example set; and the list determining section 12 that determines, from among the decision lists generated from the decision rule set, a decision list to be output, the determining being made on the basis of a prediction result calculated for the training examples included in the training example set.

With the above configuration, the decision list to be output is determined on the basis of the prediction result calculated with use of the predicted values of K (K is a natural number of not less than 2) top-ranked decision rules whose conditions are satisfied. This makes it possible to determine the decision list to be output in order to carry out prediction with use of the predicted values of the K top-ranked decision rules. Further, with such a decision list, improvement in prediction performance can be expected, as compared to the conventional methods that use only a predicted value of a rule located at the topmost in a decision list. That is, the above configuration brings about an effect of making it possible to improve prediction performance in prediction carried out with use of a decision list.

### (Configuration of Information Processing Apparatus 2)

Next, the following description will discuss the information processing apparatus 2. As shown in FIG. 1, the information processing apparatus 2 includes an input data acquiring section (input data acquiring means) 21 and a prediction section (prediction means) 22.

The input data acquiring section 21 acquires input data to be subjected to prediction.

The prediction section 22 calculates a prediction result with use of predicted values of, among decision rules included in a decision list composed of the decision rules each of which is a combination of a condition and a predicted value for a case where the condition is satisfied, K (K is a natural number of not less than 2) top-ranked decision rules whose conditions are satisfied by the input data.

As described above, a configuration is employed such that the information processing apparatus 2 according to the present example embodiment includes: the input data acquiring section 21 that acquires input data to be subjected to prediction; and the prediction section 22 that calculates a prediction result with use of predicted values of, among decision rules included in a decision list composed of the decision rules each of which is a combination of a condition and a predicted value for a case where the condition is satisfied, K (K is a natural number of not less than 2) top-ranked decision rules whose conditions are satisfied by the input data. This brings about an effect of making it possible to improve prediction performance, as compared to the conventional methods that use only a predicted value of a rule located at the topmost in a decision list.

### (Program)

The foregoing functions of the information processing apparatus 1 can also be realized by a learning program. A learning program according to an example aspect of the present invention causes a computer to function as: a prediction means that calculates a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and a list determining means that determines, from among the decision lists generated from the decision rule set, a decision list to be output, the determining being made on the basis of a prediction result calculated for the training examples included in the training example set. Thus, the learning program according to the present example embodiment brings about an effect of making it possible to improve prediction performance in prediction carried out with use of a decision list.

The foregoing functions of the information processing apparatus 2 can also be realized by a prediction program. A prediction program according to the present example embodiment causes a computer to function as: an input data acquiring means that acquires input data to be subjected to prediction; and a prediction means that calculates a prediction result with use of predicted values of, among decision rules included in a decision list composed of the decision rules each of which is a combination of a condition and a predicted value for a case where the condition is satisfied, K (K is a natural number of not less than 2) top-ranked decision rules whose conditions are satisfied by the input data. Thus, prediction program according to the present example embodiment brings about an effect of making it possible to improve prediction performance, as compared to the conventional methods that use only a predicted value of a rule located at the topmost in a decision list.

### (Flow of Learning Method)

The following description will discuss, with reference to FIG. 2, a flow of a learning method according to the present example embodiment. FIG. 2 is a flowchart illustrating a flow of the learning method and a prediction method. Note that the prediction method will be described later.

Note that steps of the learning method of FIG. 2 may be carried out by a processor of the information processing apparatus 1 or by a processor of another apparatus. Alternatively, the steps may be carried out by processors provided in respective different apparatuses.

In S11, at least one processor calculates a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set.

In S12, at least one processor determines, from among decision lists generated from the decision rule set, a decision list to be output, the determining being made on the basis of a prediction result calculated for the training examples included in the training example set.

As described above, a configuration is employed such that a learning method according to the present example embodiment includes: (a) calculating a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and (b) determining, from among the decision lists generated from the decision rule set, a decision list to be output, the determining being made on the basis of a prediction result calculated for the training examples included in the training example set, (a) and (b) being carried out by at least one processor. Thus, the learning method according to the present example embodiment brings about an effect of making it possible to improve prediction performance in prediction carried out with use of a decision list.

### (Flow of Prediction Method)

Next, the following description will discuss, with reference to FIG. 2, a flow of a prediction method according to the present example embodiment. Note that steps of the prediction method of FIG. 2 may be carried out by a processor of the information processing apparatus 2 or by a processor of another apparatus. Alternatively, the steps may be carried out by processors provided in respective different apparatuses.

In S21, at least one processor acquires input data to be subjected to prediction.

In S22, at least one processor calculates a prediction result with use of predicted values of, among decision rules included in a decision list composed of the decision rules each of which is a combination of a condition and a predicted value for a case where the condition is satisfied, K (K is a natural number of not less than 2) top-ranked decision rules whose conditions are satisfied by the input data.

As described above, a configuration is employed such that prediction method according to the present example embodiment includes: (a) acquiring input data to be subjected to prediction; and (b) calculating a prediction result with use of predicted values of, among decision rules included in a decision list composed of the decision rules each of which is a combination of a condition and a predicted value for a case where the condition is satisfied, K (K is a natural number of not less than 2) top-ranked decision rules whose conditions are satisfied by the input data, (a) and (b) being carried by at least one processor. Thus, the prediction method according to the present example embodiment brings about an effect of making it possible to improve prediction performance, as compared to the conventional methods that use only a predicted value of a rule located at the topmost in a decision rule. Note that the prediction list used in the above prediction method may be a prediction list determined in S12.

### Second Example Embodiment

The following description will discuss a second example embodiment of the present invention in detail with reference to the drawings. Note that members having identical functions to those of the first example embodiment are given identical reference signs, and a description thereof will be omitted. This is also true of a third and later example embodiments.

### (Overview)

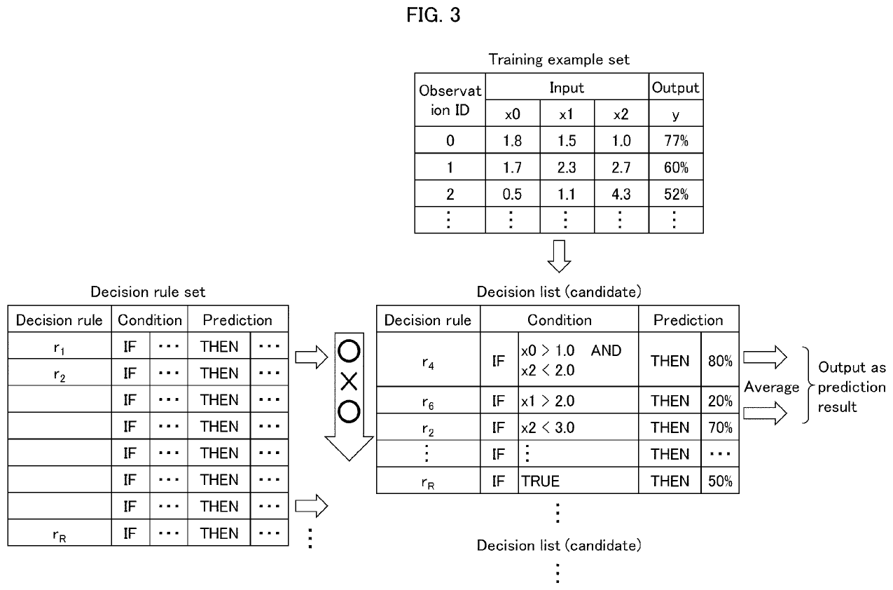

FIG. 3 is a diagram illustrating an overview of a learning method according to the present example embodiment. Similarly to the first example embodiment, also in the learning method according to the present example embodiment, a decision list is determined that is to be output and that is composed of a plurality of decision rules extracted from a decision rule set.

More specifically, in the learning method according to the present example embodiment, a plurality of candidates of decision lists (hereinafter, referred to as “candidate lists”) from the decision rule set. Subsequently, with use of the candidate lists thus generated, prediction is carried out for the training examples included in the training example set. Then, on the basis of the prediction result, a decision list to be output is determined from among the candidate lists.

For example, the decision rule set illustrated in FIG. 3 includes R decision rules from r₁ to r_{R}. Each decision rule is obtained by associating a condition (IF) with a predicted value (THEN) for a case where the condition is satisfied.

FIG. 3 illustrates, among candidate lists generated with use of the decision rules r₁ to r_{R} included in the decision rule set, a candidate list in which the decision rules r₄, r₆, r₂, . . . , r_{R} are arranged in this order. The decision rule r₄ has a condition of “x0>1.0 AND x2<2.0” and a predicted value of “80%”. The decision rule r₆ has a condition of “x1>2.0” and a predicted value of “20%”. The decision rule r₂ has a condition of “x2<3.0” and a predicted value of “70%”. The decision rule r_{R} has a condition of “TRUE” and a predicted value of “50%”. The decision rule r_{R}, which is for outputting a predicted value (50% in this example) that is always the same with respect to any input, is called a default rule.

With use of this candidate list, prediction is carried out for the training examples included in the training example set. Each of the training examples illustrated in FIG. 3 is obtained by associating, with each other, an observation ID, a numerical value ranging from x0 to x2 indicative of an input, and a numerical value of y indicative of an output. It can also be said that the input is an observed value. It can also be said that the output y is a label or ground truth data for observation. Note that an observed value is not limited to a numerical value, and may be, for example, “TRUE” (satisfying a predetermined condition) or “FALSE” (not satisfying the predetermined condition). In the example of FIG. 3, a unit of the output y is %. Note, however, that the output y only needs to be represented by a real value, and the unit thereof is arbitrary.

Note that prediction involving use of a decision list can be used both for prediction of a solution to a regression problem and for prediction of a solution to a classification problem. In the case of a decision list with use of which prediction of a solution to a regression problem is carried out, the output y is a real value as in the example of FIG. 3. In contrast, in the case of a decision list with use of which prediction of a solution to a classification problem is carried out, the output y is a probability vector indicative of a probability of belonging to each class of a classification destination.

Here, assume that prediction is carried out for a training example whose observation ID=0 in FIG. 3. In this case, the decision rules are subjected to determination, in order from higher to lower ranks, as to whether the input value “x0=1.8, x1=1.5, and x2=1.0” of the training example satisfy conditions included in the candidate list. This process is carried out until the number of decision rules whose conditions are satisfied reaches K (K is a natural number of not less than 2).

Assume here that K=2. In this case, as illustrated in FIG. 3, the condition of the first decision rule r₄ is satisfied, the condition of the second decision rule r₆ is not satisfied, and the decision rule of the third decision rule r₂ is satisfied. Thus, the determination is ended at this point. Then, the predicted values of the decision rules r₄ and r₆ whose conditions are satisfied are used to calculate a final prediction result.

For example, in the example of FIG. 3, the final prediction result is an average value (75%) of “80%”, which is the predicted value of the decision rule r₄, and “70%”, which is the predicted value of the decision rule r₆. Validity of this prediction result can be evaluated by comparison with a value of the label y, the value being shown in the training example set. Furthermore, by carrying out a similar process with respect to the training examples having observation IDs of “1” and a larger number(s), it is possible to evaluate prediction accuracy of the candidate list with respect to the training example set as a whole.

By subjecting a plurality of candidate lists to the above-described process of evaluating prediction accuracy of a candidate list, it is possible to specify a candidate list having the highest prediction accuracy, and to determine, as the decision list to be output, the candidate list having the highest prediction accuracy. This enables output of a decision list that is composed of simple rules and that also has high prediction performance.

### (Configuration of Information Processing Apparatus 3)

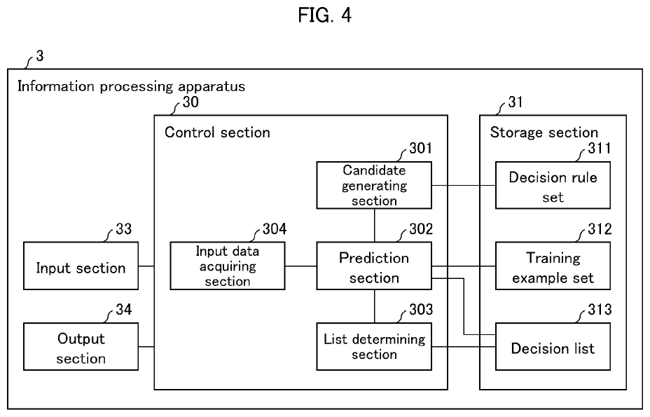

FIG. 4 is a block diagram illustrating an example of a configuration of an information processing apparatus 3 according to the present example embodiment. As illustrated in FIG. 4, the information processing apparatus 3 includes a control section 30 that collectively controls sections of the information processing apparatus 3 and a storage section 31 that stores therein various kinds of data used by the information processing apparatus 3. The information processing apparatus 3 further includes an input section 33 that accepts an input with respect to the information processing apparatus 3 and an output section 34 that allows the information processing apparatus 3 to output data.

The control section 30 includes a candidate generating section 301, a prediction section 302, a list determining section 303, and an input data acquiring section 304. The storage section 31 stores therein a decision rule set 311, a training example set 312, and a decision list 313.

The decision rule set 311 is, as described earlier, a set including a plurality of decision rules that can be used to generate a decision list. The training example set 312 is a set of a plurality of training examples for use in learning, i.e., determination of an optimal decision list. The training examples are each composed of a combination of an input x and an output y. The decision list 313 is a decision list that has been determined by the list determining section 303 to be output.

The candidate generating section 301 uses the decision rules included in the decision rule set 311 to generate a candidate list, which includes candidates of the decision list. More specifically, the candidate generating section 301 generates a plurality of candidate lists which are different from each other at least either in the number of decision rules included therein and the order of arrangement of the decision rules. For example, the candidate generating section 301 may generate candidate lists of all patterns that can be generated with use of the decision rules included in the decision rule set 311.

The prediction section 302 calculates a prediction result with use of predicted values of, among decision rules included in a candidate list generated by the candidate generating section 301, K (K is a natural number of not less than 2) top-ranked decision rules whose conditions are satisfied by one of training examples included in the training example set 312. After the list determining section 303 determines a decision list to be output and the storage section 31 stores therein the decision list as the decision list 313, the prediction section 302 uses the decision list 313 to carries out prediction.

For each of the training examples included in the training example set 312, the list determining section 303 determines a decision list to be output, on the basis of the prediction result that the prediction section 302 calculates for the plurality of candidate lists generated by the candidate generating section 301. The decision list to be output is stored, as the decision list 313, in the storage section 31.

The input data acquiring section 304 acquires input data to be subjected to prediction involving use of the decision list 313. Thus, the input data is data which is in a form similar to that of a training example used for learning of the decision list 313. For example, as in the example shown in FIG. 3, in a case where the decision list 313 is used that has been output by learning involving use of a training example including an input of x0, x1, and x2, the input data acquiring section 304 acquires input data indicative of at least any one of the values x0, x1, and x2.

### (Flow of Learning Method)

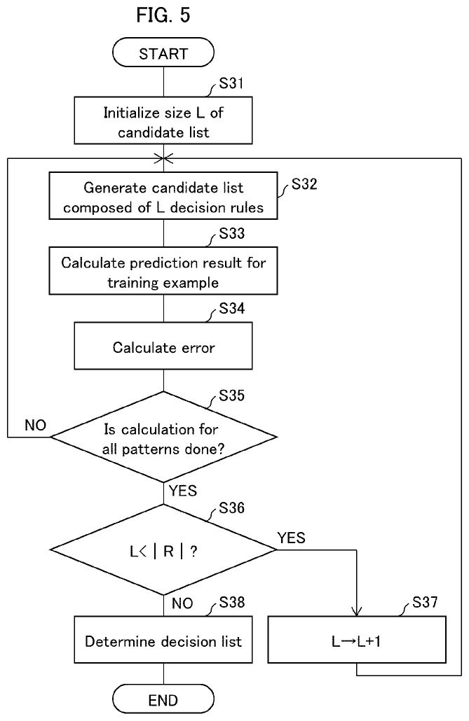

The following description will discuss, with reference to FIG. 5, a flow of a learning method executed by the information processing apparatus 3. FIG. 5 is a flowchart illustrating a flow of the learning method executed by the information processing apparatus 3.

In S31, the candidate generating section 301 initializes a size L of a candidate list. Note that L indicates the number of decision rules included in the candidate list. An initial value of L may be a minimum value of L, for example, 1.

In S32, the candidate generating section 301 generates a candidate list composed of an L decision rule(s). For example, the candidate generating section 301 may generate a candidate list by arbitrarily extracting an L decision rule(s) from the decision rule set 311 and arbitrarily rearranging the L decision rule(s).

In S33, the prediction section 302 uses the candidate list generated in S32 to calculate a prediction result for training examples included in a training example set 312. The prediction result is calculated with use of predicted values of K top-ranked decision rules whose conditions are satisfied by a training example, among a plurality of decision rules included in the candidate list. For example, the prediction section 302 may calculate, as a prediction result, an average value of the predicted values of the K top-ranked decision rules.

In S34, the list determining section 303 calculates an error of the prediction result calculated in S33 with respect to an output value y indicated for the training example set 312. The error may be calculated by any method. For example, the list determining section 303 may calculate a squared error. In this case, the list determining section 303 calculates a difference between the prediction result given by the prediction section 302 and the output value y, and squares the difference to yield an error.

In S35, the list determining section 303 determines whether or not errors of candidate lists of all patterns that should be tested have been already calculated. If the list determining section 303 determines “NO” in S35, the process returns to S32, and a candidate list(s) not having generated is/are generated. Meanwhile, if the list determining section 303 determines “YES” in S35, the process advances to S36.

Note that all the patterns that should be tested may be set in advance. For example, candidate lists of all the patterns which have a size L and which can be generated from decision rules included in the decision rule set 311 may be subjected to testing.

In S36, the list determining section 303 determines whether or not the current size L is smaller than |R|, which is the number of decision rules included in the decision rule set 311. If the list determining section 303 determines “YES” in S36, the process advances to S37. In S37, the list determining section 303 increments L by 1. Then, the process returns to S32, and a candidate list is generated on the basis of L having been incremented. Meanwhile, if the list determining section 303 determines “NO” in S36, the process advances to S38.

In S38, the list determining section 303 determines a decision list to be output. Specifically, the list determining section 303 determines, as a decision list to be output, a candidate list whose error calculated in S34 is the smallest. The list determining section 303 then stores the determined decision list, as the decision list 313, in the storage section 31. This ends the process of FIG. 5.

Note that, instead of the configuration in which the candidate lists of all the patterns are generated for each value of size L, a configuration may be employed such that candidate lists of some of the patterns are generated and, from among these candidate lists, a candidate list whose error is the smallest is determined as a decision list to be output. In this case, there is a possibility that the decision list determined to be output may not be an optimal decision list. However, it is possible to reduce the time and amount of calculation required for learning.

Further, at the time when the error calculated in S34 becomes not more than a predetermined threshold, a candidate list whose error is not more than the threshold may be determined as a decision list to be output. Also in this case, there is a possibility that an optimal decision list may not be selected as a decision list to be output. However, it is possible to reduce the time and amount of calculation required for learning.

### (Flow of Prediction Method)

The prediction method executed by the information processing apparatus 3 is similar to the prediction method shown in FIG. 2. Specifically, first, the input data acquiring section 304 acquires input data to be subjected to prediction (S21). Then, the prediction section 302 calculates predicted values of, among the decision rules included in the decision list 313, K top-ranked decision rules whose conditions are satisfied by the input data acquired in S21, and uses the predicted values to calculate a prediction result.

### Third Example Embodiment

### (Overview)

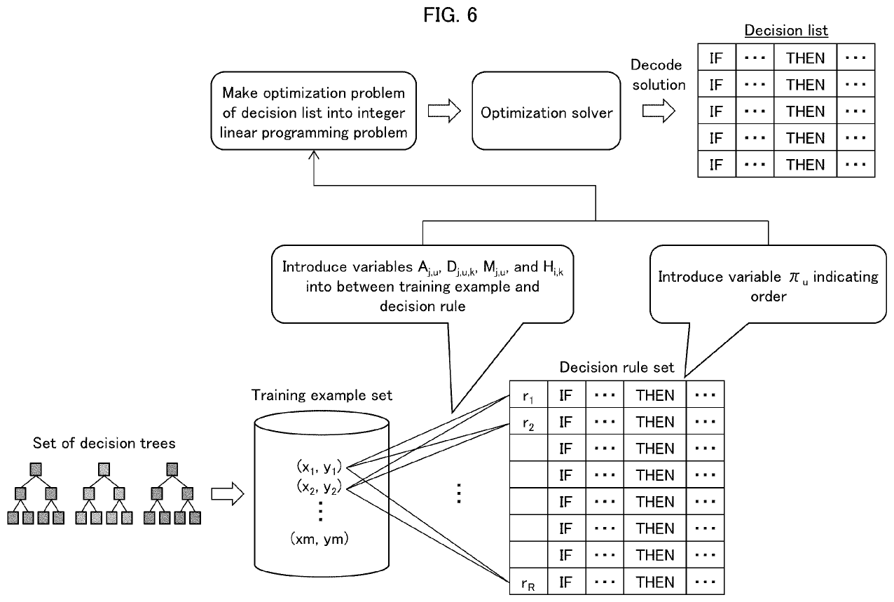

FIG. 6 is a diagram illustrating an overview of a learning method according to the present example embodiment. Similarly to the first and second example embodiments, also in the learning method according to the present example embodiment, a decision list is determined that is to be output and that is composed of a plurality of decision rules extracted from a decision rule set.

More specifically, in the learning method according to the present example embodiment, four variables A_{j,u}, D_{j,u,k}, M_{j,u}, and H_{i,k} are introduced between a training example included in the training example set and a decision rule included in the decision rule set. Further, variables πᵤ and δ_{u,j}, which indicate the order of the decision rules, are introduced.

Though described in detail later, introduction of these variables enables an optimization problem of a decision list to be an integer linear programming problem (hereinafter, referred to as integer linear programming (ILP)). ILP can be efficiently and quickly solved with use of a known optimization solver, and an optimal decision list is determined by decoding the resulting solution. Examples of an applicable optimization solver include Gurobi and CPLEX.

The description of the present example embodiment also discusses a process of generating a training example set from a set of decision trees. In the learning method according to the present example embodiment, it is not essential to generate a training example set from a set of decision trees. Furthermore, the training example set used in the learning method according to the present example embodiment is not limited to a training example set generated from a set of decision trees, and may alternatively be any training example set generated in any manner.

### (Configuration of Information Processing Apparatus 4)

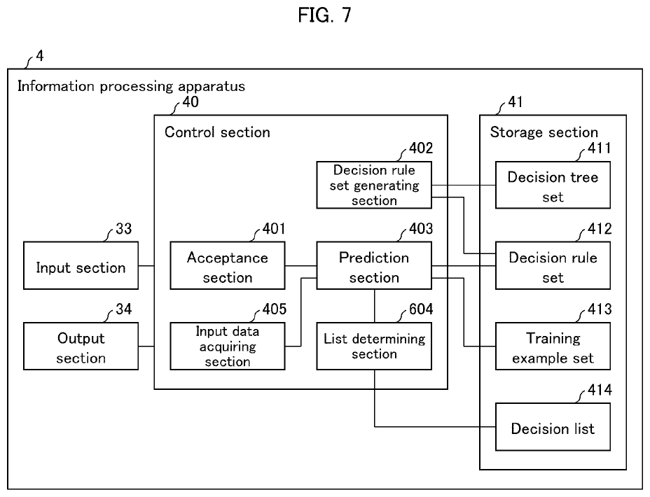

FIG. 7 is a block diagram illustrating an example of a configuration of an information processing apparatus 4 according to the present example embodiment. As illustrated in FIG. 7, the information processing apparatus 4 includes a control section 40 that collectively controls sections of the information processing apparatus 4 and a storage section 41 that stores therein various kinds of data used by the information processing apparatus 4. The information processing apparatus 4 further includes an input section 33 and an output section 34.

The control section 40 includes an acceptance section 401, a decision rule set generating section 402, a prediction section 403, a list determining section 404, and an input data acquiring section 405. The storage section 41 stores therein a decision tree set 411, a decision rule set 412, a training example set 413, and a decision list 414. Note that the input data acquiring section 405 and the training example set 413 are similar to the elements having the same names as those in the second example embodiment.

The acceptance section 401 accepts setting of a value of a parameter K. The parameter K indicates the number of decision rules for use in calculation of a final prediction result. For example, the acceptance section 401 may accept, as a set value of the parameter K, the value of K, the value having been input via the input section 33.

The decision rule set generating section 402 generates a decision rule by extracting, from a decision tree included in the decision tree set 411 including at least one decision tree, each condition appearing on a path from a root to a leaf of the decision tree, and generates a decision rule set including the generated decision rule. In other words, the decision rule set generating section 402 generates a decision rule in which a value of a leaf (endpoint) of a decision tree is used as an output value y, and each condition appearing on a path from a root to the leaf of the decision tree is used an input value x. Then, the decision rule set generating section 402 generates a decision rule set by carrying out the above process with respect to each of leaves (endpoints) of the decision tree. The decision rule set generating section 402 also stores, in the storage section 41, the generated decision rule set as the decision rule set 412.

Note that the decision rule set generating section 402 is not an essential component of the information processing apparatus 4. The decision rule set generating section 402 can alternatively be omitted. In this case, similarly to the second example embodiment, the information processing apparatus 4 uses the decision rule set 311 preliminarily stored, to determine a decision list to be output.

The prediction section 403 calculates a prediction result with use of predicted values of, among decision rules included in a decision list composed of the decision rules extracted from the decision rule set 412, K (K is a natural number of not less than 2) top-ranked decision rules whose conditions are satisfied by one of training examples included in the training example set 413.

The list determining section 404 determines, from among a plurality of decision lists generated from the decision rule set 412, a decision list to be output, the determining being made on the basis of a prediction result calculated for the training examples included in the training example set 413.

As described above, the information processing apparatus 4 includes the acceptance section 401 that accepts setting of a value of the parameter K indicative of the number of decision rules for use in calculation of a final prediction result, and the prediction section 403 uses the value of K accepted by the acceptance section 401 to calculate a prediction result.

The above configuration brings about, in addition to the effect given by the information processing apparatus according to the first example embodiment, an effect of enabling a user who sets a value of K at a desired value to determine a decision list suitable to calculate a prediction result with use of the value of K. Consequently, for example, when wishing to attach great importance to prediction performance, the user can set K at a great value. Meanwhile, when wishing to attach great importance to explainability of a prediction result, the user can set K at a small value. That is, the above configuration enables the user to freely set a tradeoff between prediction performance and explainability.

The present example embodiment assumes that K is set at a value of not less than 2. Alternatively, K can be set at 1. The second example embodiment may be configured such that the acceptance section 401 accepts setting of a value of K.

As described above, the information processing apparatus 4 includes the decision rule set generating section 402 that (a) generates a decision rule by extracting, from a decision tree included in the decision tree set 411 including at least one decision tree, each condition appearing on a path from a root to a leaf of the decision tree and (b) generates a decision rule set 412 including the generated decision rule.

The above configuration brings about, in addition to the effect given by the information processing apparatus 1 according to the first example embodiment, an effect of making it possible to automatically generate a decision rule set on the basis of a decision tree.

The decision tree set may also be a set of decision trees for use in a random forest. The random forest is a method in which (a) a set of decision trees is generated from training examples, (b) the decision trees in the set are used to carry out prediction, and (c) respective expectation results of the decision trees are integrated into a final prediction result. Thus, in a case where a prediction list is used that is generated from a decision rule set generated from a set of decision trees for use in the random forest, it is possible to carry out prediction by a method similar to that of the random forest. This makes it possible to achieve high prediction performance as in the random forest.

### (Optimization Problem of Decision List)

The prediction section 403 and the list determining section 404 solve an optimization problem of a decision list so as to determine a decision list to be output. As described in the overview, the optimization problem solved by the prediction section 403 and the list determining section 404 is ILP. The following description will discuss a method for allowing the optimization problem of the decision list to be ILP.

An optimization problem of a decision list L_{K} in which predicted values of K top-ranked decision rules whose conditions are satisfied are used to yield a final prediction result can be defined as a problem for finding the decision list L_{K} that minimizes the following objective function. Note that λ (a real number) is a regularization parameter. Note also that the decision list L_{K} is composed of decision rules included in a decision rule set R.

$${f}_{opt \_ k} = {1}_{err} ( {L}_{k} , T ) + λ \vert {L}_{k} \vert$$

A training example can be represented by a pair (x,y) of the input x (x is a real number) and the output y. This allows a training example set T composed of m training examples to be represented as follows:

$$T = {\{ ( {x}^{( i )} , {y}^{( i )} ) \}}_{i = 1}^{m}$$

As described above, a decision list is also applicable to either of prediction of a solution to a regression problem and prediction of a solution to a classification problem. In the case of a regression problem, y is a real value. In the case of a classification problem, y is a probability vector indicative of a probability of belonging to each class.

Note here that lₑᵣᵣ(Lₖ,T) is an error function with respect to prediction involving use of the decision list Lₖ on the training example set T. λ|Lₖ| is a regularization term that gives a penalty to the decision list Lₖ having a large size.

In the case of a regression problem, lₑᵣᵣ(Lₖ, T) can be, for example, a mean squared error (MSE), which is one of typical error functions. In the case of a classification problem, KL divergences (Kullback-Leibler divergences) between true values and predicted values output by a decision list may be calculated, and a sum of the KL divergences in an entirety of training examples may be used as an error function. A KL divergence is also referred to as an information gain.

The decision list L_{K} can also be defined as follows:

$${L}_{K} = ( {l}_{1} , … , {l}_{n} , {\tilde{l}}_{1} , … , {\tilde{l}}_{K} )$$

In the decision list L_{K},
\tilde{l}₁, . . . , \tilde{l}_{K}
are default rules, and are all an identical default rule l₀.

In prediction involving use of the decision list L_{K}, the following is carried out. That is, with respect to the example x, l=p→q∈L_{K} is viewed in order from higher to lower ranked decision rules in the decision list L_{K}, and an average value of respective postconditions q of K top-ranked decision rules in which x satisfies a condition p is output as a predicted value L_{K}(x). A decision rule 1 in which x satisfies the condition p in a k-th place in list order with respect to 1≤k≤K is referred to as a k-th decision rule on the decision list L_{K} with respect to x.

Default rules included in a decision list L_{K} having been subjected to optimization are given in advance, and K decision rules r_{|R|-K+1}, . . . , r_{|R|} in a given rule set R={r₁, . . . , r_{|R|}} correspond to the default rules.

The decision list L_{K} having been subjected to optimization is output as below.

$${L}_{K} = ( {l}_{1} , … , {l}_{j} , {\tilde{l}}_{1} , … , {\tilde{l}}_{K} , {l}_{j + K} , … {l}_{\vert R \vert} )$$

Rules l_{j+K}, . . . , l_{|R|} after the decision rules are not used for prediction. Therefore, the decision rules l_{j+K}, . . . , l_{|R|} are eventually removed from the decision list L_{K}.

A height (rank) of a certain rule lᵤ in the decision list L_{K} is defined by |R|−u+1. A relation between R and a decision rule r included in the decision list L_{K} is represented as a decision rule rᵤ=l_{|R|-πu+1} with use of the later-described rearrangement vector π.

Here, the following variables are introduced so that ILP transformation is carried out.

A: a binary matrix of m×|R|. An element Aᵢᵤ in the matrix satisfies the following. That is, if observation x⁽ⁱ⁾ satisfies a condition of a decision rule rᵤ, Aᵢᵤ is 1. Otherwise, Aᵢᵤ is 0.

$${A}_{iu} = \{ \begin{matrix}1 & ( If example {x}^{( i )} satisfies condition of rule {r}_{u} ) \\ 0 & ( otherwise )\end{matrix}$$

D: a binary tensor of m×|R|×K. An element Dᵢᵤₖ in the tensor satisfies the following. That is, if the decision rule rᵤ is used as prediction of observation x⁽ⁱ⁾, Dᵢᵤₖ is 1. Otherwise, Dᵢᵤₖ is 0.

$${D}_{iuk} = \{ \begin{matrix}1 & ( If k - th prediction rule on {L}_{K} with respect to {X}^{( i )} is {R}_{u} ) \\ 0 & ( otherwise )\end{matrix}$$

M: a real number matrix of m×|R|. An element Mᵢᵤ in the matrix is an error of y⁽ⁱ⁾ with respect to the predicted value of the decision rule rᵤ. For example, in the case of a regression problem, this error may be a squared error. In the case of a classification problem, this error may be a sum of KL divergences.

H: an integer matrix having a size of m×K. An element Hᵢₖ indicates a height (rank) of the k-th decision rule in the decision list L_{K} with respect to x⁽ⁱ⁾.

π: an integer vector having a size of |R|. An element is πᵤ∈{1, . . . , |R|}, and indicates a height (rank) of the decision rule rᵤ in the decision list L_{K}.

δ: a binary matrix of |R|×|R|. This indicates that a height (rank) of the decision rule rᵤ in the decision list L_{K} is j, in a case where δᵤⱼ=1.

Use of the above variables makes it possible to formulate the optimization problem of the decision list L_{K} by ILP in the following manner.

$${max}_{π , H , D} {{\sum }^{m}}_{i = 1} {{\sum }^{\vert R \vert}}_{u = 1} \frac{{M}_{iu}}{K} {{\sum }^{K}}_{k = 1} {D}_{iuk} + λ ( \vert R \vert - {π}_{\vert R \vert - K + 1} ) s . t . \qquad ( 1 )$$

$${H}_{ik} \geq {A}_{iu} {π}_{u} , ∀ i , u , k = 1 , \qquad ( 2 )$$

$${H}_{ik} \geq {A}_{iu} {π}_{u} - \vert R \vert \times {{\sum }^{k - 1}}_{{k}^{′} = 1} {D}_{{iuk}^{′}} , ∀ i , u , 2 \leq ∀ k \leq K , \qquad ( 3 )$$

$${H}_{ik} \leq {A}_{iu} {π}_{u} + \vert R \vert \times ( 1 - {{\sum }^{k - 1}}_{{k}^{′} = 1} {D}_{{iuk}^{′}} ) , ∀ i , u , k , \qquad ( 4 )$$

$${{\sum }^{\vert R \vert}}_{u = 1} {D}_{iuk} = 1 , ∀ i , k , \qquad ( 5 )$$

$${π}_{\overline{u}} = {π}_{\overline{u} + 1} + 1 , \vert R \vert - K + 1 \leq ∀ \tilde{u} \leq \vert R \vert \qquad ( 6 )$$

$${π}_{u} = {{\sum }^{\vert R \vert}}_{j = 1} j {δ}_{uj} , ∀ u \qquad ( 7 )$$

$${{\sum }^{\vert R \vert}}_{j = 1} {δ}_{uj} = 1 , ∀ u , AND , {{\sum }^{\vert R \vert}}_{u = 1} {δ}_{uj} = 1 , ∀ j \qquad ( 8 )$$

The formula (1) indicated above is an objective function. The first term in the formula (1) is an error term corresponding to a prediction error in the objective function used for the optimization problem of the decision list L_{K} (described earlier). Assume that the following is applied with respect to i and u.

Σₖ₌₁^{K}Dᵢᵤₖ=1

This indicates that, with respect to example xᵢ, the decision rule rᵤ is used as one of the K decision rules. In this case, a prediction error is Mᵢᵤ. By summing all of 1≤u≤|R|, it is possible to represent, on an ILP formula, that the K decision rules are used for one example.

The second term in the formula (1) corresponds to the second term in the foregoing objective function: f_{opt_k}=lₑᵣᵣ(Lₖ, T)+λ|Lₖ|, and is a regularization term that gives a penalty to the decision list Lₖ having a large size. For example, the second term may give a larger penalty value as more decision rules are included in the decision list. Alternatively, the second term may give a larger penalty value as more conditions are included in a decision rule included in the decision list.

The above-indicated formulae (2) to (6) represent constraints in optimization. Specifically, each of the formulae (2) and (3) indicates that, when a certain rule is a k-th decision rule with respect to a certain example, the certain rule has the highest priority in the decision list L_{K} among k-th, . . . , K-th decision rules.

Further, the formula (4) indicates that, when a certain rule is a k-th decision rule with respect to a certain example, the certain rule has lower priority in the decision list L_{K} than those of the first, . . . , k−1-th decision rules. Thus, by the formulae (2) to (4), it is possible to indicate a condition that a certain decision rule is a k-th decision rule with respect to a certain example.

The formula (5) ensures that, among K decision rules satisfying a condition of a certain example, a single decision rule becomes a k-th decision rule. The formula (6) ensures that K default rules are arranged in a continuous manner in the decision list L_{K}.

The formula (7) is a constraint that gives a relation between π and δ. Further, the formula (8) ensures that each rule is not redundant in the decision list L_{K}.

The above calculation method differs from the technique of Non-patent Literature 1 in that the variable D is a tensor to which a dimension for indicating K is added and the variable H is a matrix to which a dimension for indicating K is added. Further, along with changing the variables D and H in the above-described manner, a constraint formula different from that of the technique of Non-patent Literature 1 is used. Non-patent Literature 1 neither describes nor suggests such extension. Thus, it is not obvious to arrive at the configuration of the present example embodiment on the basis of Non-patent Literature 1.

### (Method for Determining Decision List to be Output)

The prediction section 403 and the list determining section 404 use the above formulae (2) to (8) to search for the variables A_{j,u}, D_{j,u,k}, M_{j,u}, H_{i,k}, πᵤ, and δ_{u,j} when a value of the objective function represented by the formula (1) satisfies a predetermined condition. Note that these variables allow indication of a position in a decision list at which position a decision rule included in a decision rule set is located. The predetermined condition is a condition for determining whether to end optimization, and is determined in advance.

Specifically, first, the list determining section 404 sets each of the foregoing variables at an initial value. Then, the prediction section 403 calculates a value of the objective function with use of a decision list represented by each of those variables. In a case where the calculated value does not satisfy the predetermined condition, the list determining section 404 updates the foregoing variables. Until the predetermined condition is satisfied, the prediction section 403 and the list determining section 404 repeatedly update the variables and repeatedly calculate the value of the objective function. This specifies values of the variables indicating an optimal decision list.

In this manner, the prediction section 403 calculates, with use of the decision list represented by the variables indicative of a position in the decision list at which position a decision rule included in the decision rule set is located, the value of the objective function (the formula (1)) including the error term (the first term of the formula (1)) indicative of an error of the prediction result. Further, the list determining section 404 determines repeatedly carries out the process of updating the variables on the basis of the calculated value of the objective function until the value of the objective function satisfies the predetermined condition, thereby determining a decision list to be output.

The above configuration brings about, in addition to the effect given by the information processing apparatus 1 according to the first example embodiment, an effect of making it possible to determine a decision list to be output by optimization calculation involving use of an objective function.

Further, as in the above-described example, the objective function may be represented by a linear function, and a constraint condition of optimization may be described by an equality or an inequality in the linear function. With this, it is possible to make a problem for determining the optimal decision list into ILP, and to use an optimization solver to efficiently determine a decision list to be output.

Further, as described above, the prediction section 403 calculates the value of the objective function including the constraint term (the second term in the formula (1)) relating to the number of decision rules included in the decision list. Further, the constraint term may be a constraint term relating to the number of conditions included in the decision rules included in the decision list.

The above configuration uses an objective function including the constraint term relating to the number of decision rules included in the decision list or the number of conditions included in the decision rules included in the decision list. This can bring about, in addition to the effect given by the information processing apparatus 1 according to the first example embodiment, an effect of making it possible to determine a decision list including a constraint which is the number of decision rules included in the decision list or the number of conditions included in the decision rules included in the decision list. For example, it is also possible to determine a decision list having a small number of decision rules or a small number of conditions, i.e., a decision list which is composed of simple decision rules and whose interpretability for the user is high.

As described above, variables introduced between a training example included in the training example set 413 and a decision rule included in the decision rule set 412 include, for each of the training examples included in the training example set 413, variables D_{j,u,k} and H_{i,k} indicative of K decision rules, i.e., the first to K-th decision rules in the decision list, whose conditions are each satisfied by the training example.

According to the above configuration, the variables D_{j,u,k} and H_{i,k} represent the K decision rules, i.e., the first to K-th decision rules, whose conditions are satisfied by the training examples, that is, the K decision rules used for calculation of predicted values of the training examples. Thus, with these variables, it is possible to represent the prediction result for the training examples and an error thereof, and also to represent a value of the objective function. Further, it is possible to obtain values of the variables with which a decision list becomes optimal. Thus, the above configuration brings about, in addition to the effect given by the information processing apparatus 1 according to the first example embodiment, an effect of making it possible to determine a decision list to be output by optimization calculation involving use of an objective function.

### (Flow of Learning Method)

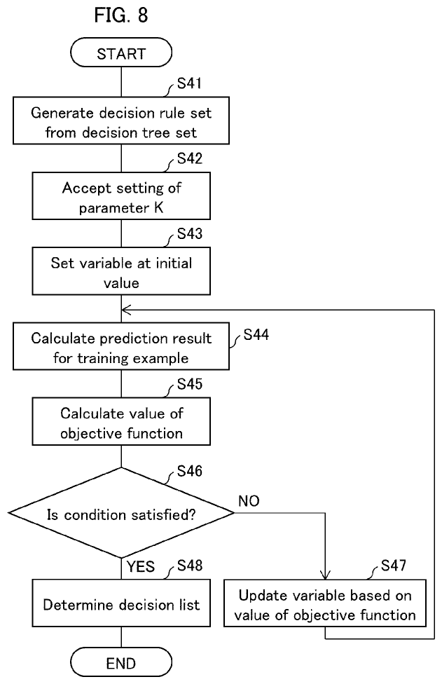

The following description will discuss, with reference to FIG. 8, a flow of a learning method executed by the information processing apparatus 4. FIG. 8 is a flowchart showing a flow of the learning method executed by the information processing apparatus 4.

In S41, the decision rule set generating section 402 generates a decision rule set from the decision tree set 411. The decision rule set generating section 402 stores, in the storage section 41, the generated decision rule set as the decision rule set 412.

Note that the decision tree set 411 may be generated by a random forest as described earlier. In this case, the information processing apparatus 4 may carry out, in advance of S41, a process of generating the decision tree set by the random forest.

In S42, the acceptance section 401 accepts setting of the value of the parameter K. A user of the information processing apparatus 4 can input a desired value of the parameter K via, for example, the input section 33. The acceptance section 401 carries out setting so that the value thus input is set at the value of the parameter K.

In S43, the list determining section 404 sets each of various variables at an initial value. Specifically, the list determining section 404 sets, at the initial value, each of values of the foregoing six variables, i.e., A_{j,u}, D_{j,u,k}, M_{j,u}, H_{i,k}, πᵤ, and δ_{u,j}.

In S44, the prediction section 403 calculates, with use of the variables each of which has been set at the initial value in S43, a prediction result for training examples included in the training example set 413. The prediction result is calculated with use of predicted values of, among a plurality of decision rules included in a decision list represented with use of the above variables, K top-ranked decision rules whose conditions are satisfied by a training example.

In S45, the list determining section 404 calculates a value of an objective function with use of the prediction result calculated in S44. Specifically, the list determining section 404 calculates a value of the formula (1) (described earlier), which represents the objective function.

In S46, the list determining section 404 determines whether or not a result of the calculation in S45 satisfies a predetermined condition. If the list determining section 404 determines “YES” in S46, the process advances to S48. In contrast, if the list determining section 404 determines “NO” in S46, the process advances to S47.

In S47, the list determining section 404 updates the values of the foregoing six variables on the basis of the value of the objective function, the value having been calculated in S45. Updating may be carried out by a method that enables the value of the objective function to change in a direction in which the predetermined condition is satisfied. Thereafter, the process returns to S44.

In S48, the list determining section 404 determines, as a decision list to be output, a decision list specified by the values of the six variables applied when it is determined in S46 that the condition is satisfied. This makes it possible to output a decision list that is composed of simple rules and that also has high prediction performance. Then, the list determining section 404 stores the determined decision list, as a decision list 414, in the storage section 41. This ends the process of FIG. 8.

In the above-described process, the variables are updated in S47, so that the decision list specified by the variables is updated. For the updated decision list, the prediction result is calculated in S44. Thus, it can be said that, in S48, a decision list to be output is determined from among a plurality of decision lists generated from the decision rule set, the determining being made on the basis of a prediction result calculated for training examples included in the training example set. The above-described process (in particular, S43 to S48) can alternatively be executed by an optimization solver.

### (Flow of Prediction Method)

The prediction method executed by the information processing apparatus 4 is similar to the prediction method shown in FIG. 2. Specifically, first, the input data acquiring section 405 acquires input data to be subjected to prediction (S21). Subsequently, the prediction section 403 calculates predicted values of, among decision rules included in the decision list 414, K top-ranked decision rules whose conditions are satisfied by the input data acquired in S21, and uses the predicted values to calculate a prediction result.

### Fourth Example Embodiment

### (Configuration of Information Processing Apparatus 5)

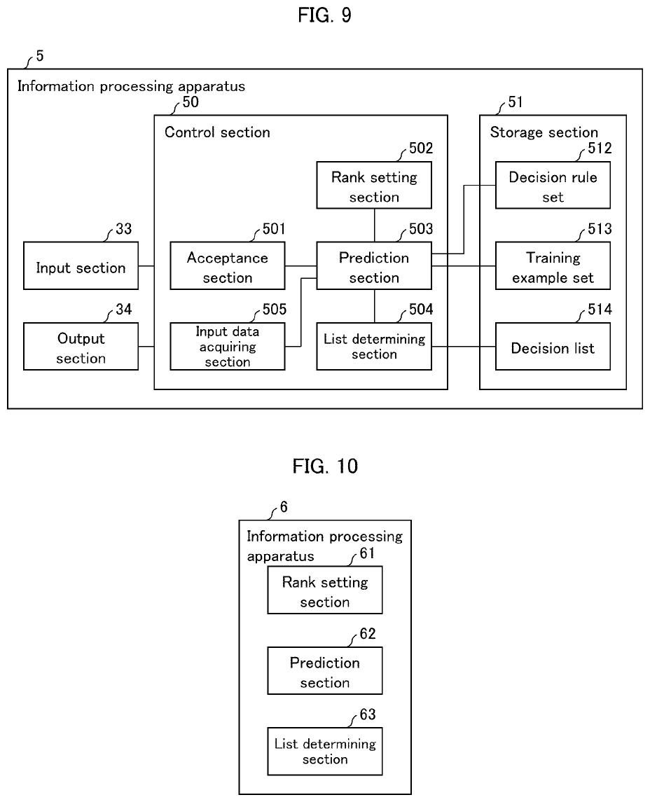

FIG. 9 is a block diagram illustrating an example of a configuration of an information processing apparatus 5 according to the present example embodiment. As illustrated in FIG. 9, the information processing apparatus 5 includes a control section 50 that collectively controls sections of the information processing apparatus 5 and a storage section 51 that stores therein various kinds of data used by the information processing apparatus 5. The information processing apparatus 5 further includes an input section 33 and an output section 34.

The control section 50 includes an acceptance section 501, a rank setting section 502, a prediction section 503, a list determining section 504, and an input data acquiring section 505. The storage section 51 stores therein a decision rule set 512, a training example set 513, and a decision list 514. Note that the acceptance section 501, the input data acquiring section 505, the decision rule set 512, and the training example set 513 are similar to the elements having the same names as those in the third example embodiment.

The rank setting section 502 ranks decision rules included in the decision rule set 512. A method of ranking the decision rules will be described later.

The prediction section 503 calculates a prediction result with use of predicted values of, among decision rules included in a decision list composed of the decision rules extracted from the decision rule set 512, K (K is a natural number of not less than 2) top-ranked decision rules whose conditions are satisfied by one of training examples included in the training example set 513. In calculation of the prediction result, the prediction section 503 calculates the prediction result with use of the K predicted values that are top-ranked by the rank setting section 502.

The list determining section 504 determines, from among a plurality of decision lists generated from the decision rule set 512, a decision list to be output, the determining being made on the basis of a prediction result calculated for the training examples included in the training example set 513. Note that the method in which the prediction section 503 calculates the prediction result and the method in which the list determining section 504 determines the decision list will be described in detail later.

As described above, the information processing apparatus 5 includes the rank setting section 502 that ranks the decision rules included in the decision rule set, and the prediction section 503 calculates the prediction result with use of the K top-ranked predicted values.

According to the above configuration, the decision rules are ranked, and the prediction result is calculated with use of the K top-ranked predicted values. This eliminates the need to consider, in determining a decision list to be output, the order of arrangement of the decision rules in the decision list.

For example, assume a decision list including three decision rules, i.e., decision rules A to C. In a case where the order of arrangement of the decision rules in this decision list is considered, it is necessary to select one of six patterns, i.e., A-B-C, A-C-B, B-A-C, B-C-A, C-A-B, and C-B-A.

In contrast, with the decision rules A to C which are ranked, it is possible to determine, on the basis of the ranking, a single pattern to be output. For example, in a case where the decision rules are ranked in the order of A-B-C, decision rules to be included in a decision list to be output may be arranged in the order of A-B-C.

As described above, the above configuration brings about, in addition to the effect given by the information processing apparatus 1 according to the first example embodiment, an effect of making it possible to complete, in a shorter time, the process of determining the decision list to be output as compared to the case where the process is carried out in consideration of the order of arrangement is considered.

### (Specific Example of Ranking)

As described above, in prediction involving use of a decision list, decision rules are checked in order from higher to lower ranks so as to find K top-ranked decision rules whose conditions are satisfied, and a final prediction result is calculated from predicted values of the K top-ranked decision rules.

It is therefore preferable that (a) a more common decision rule that applies to a large number of examples be lower-ranked in the decision list and (b) a special decision rule that applies only to a small number of examples be higher-ranked in the decision list.

Thus, for example, the rank setting section 502 may count the number of training examples that satisfy conditions of decision rules included in the decision rule set 512, and may rank the decision rules in ascending order of the number.

In the decision list, a decision rule with a highly reliable prediction result is desirably higher-ranked than a decision rule with an ambiguous prediction result.

Thus, in order to set a rank of a decision rule for predicting a solution to a regression problem, the rank setting section 502 may calculate, for the decision rules included in the decision rule set 512, a standard deviation of predicted values (outputs y) of training examples that satisfy a condition of a decision rule. Then, the rank setting section 502 may rank the decision rules in ascending order of the calculated standard deviation.

In order to set a rank of a decision rule for predicting a solution to a classification problem, the rank setting section 502 may carry out ranking on the basis of a difference between a predicted value for a training example that satisfies a condition of a decision rule and a predicted value to be compared.

The predicted value to be compared may be, for example, a predicted value of the default rule described earlier. In this case, the rank setting section 502 uses prediction of the default rule as a reference to rank the decision rules in order in which prediction is more successfully narrowed down than prediction of the default rule.

An indicator for evaluating whether or not prediction is successfully narrowed down may be, for example, a KL divergence. In order to carry out ranking with use of the KL divergence, the rank setting section 502 calculates the KL divergences for predicted values of the default rules and predicted values of the decision rules included in the decision rule set 512, and ranks the decision rules in descending order of a value of the KL divergence.

In this manner, the rank setting section 502 may rank the decision rules on the basis of differences between the predicted value for the training examples that satisfy conditions of the decision rules and the predicted values to be compared. This configuration brings about, in addition to the effect given by the information processing apparatus 1 according to the first example embodiment, an effect of making it possible to rank the decision rules in descending order of the possibility of calculating a more appropriate predicted value. According to this configuration, the optimization calculation involving use of the objective function includes a heuristics element such as a KL divergence, and therefore approximate optimization is carried out.

### (Optimization Problem of Decision List)

As described earlier, the information processing apparatus 5 includes the rank setting section 502. Therefore, the list determining section 504 does not need to consider rearrangement of the decision rules, but only needs to individually determine whether or not each of the decision rules is to be included into a decision list. Thus, in the present example embodiment, the optimization problem of the decision list is more simplified than in the third example embodiment.

Specifically, instead of π used in the third example embodiment, a binary vector γ having a size of |R| is introduced. Assume γ where an element γᵤ is 1. This means that a decision rule rᵤ is included in the decision list L_{K}. Thus, an empty, initialized decision list may be prepared, and then all of 1≤u≤|R| may be checked for γᵤ in order from 1 to |R|. Then, only in a case where γᵤ=1, the decision rule rᵤ may be added to the end of the decision list L_{K} in order. This can yield an optimal decision list L_{K}.

Along with this, the objective function in the formula (1) is changed as in the following formula (9). Comparing to the formula (1), the formula (2) is changed in the second term, which is a regularization term that gives a penalty to a decision list Lₖ having a large size. Note that the second term is also a constraint term.

$${\sum }_{u = 1}^{\vert R \vert} {γ}_{u} \qquad ( 9 )$$

$${max}_{{H}^{′} , D , γ} {{\sum }^{m}}_{i = 1} {{\sum }^{\vert R \vert}}_{u = 1} \frac{{M}_{iu}}{K} {{\sum }^{K}}_{k = 1} {D}_{iuk} + λ {{\sum }^{\vert R \vert}}_{u = 1} {γ}_{u}$$

This is because that a size of the decision list L_{K} can be represented as below.

$${\sum }_{u = 1}^{\vert R \vert} {γ}_{u}$$

Further, the formulae (2) to (4) and (6) representing constraint conditions are respectively changed as below.

$${H}_{ik}^{′} \geq ( \vert H \vert - u + 1 ) {A}_{iu} {γ}_{u} , ∀ i , u , k = 1 , \qquad ( 10 )$$

$${H}_{ik}^{′} \geq ( \vert H \vert - u + 1 ) {A}_{iu} {γ}_{u} - \vert R \vert {{\sum }^{k - 1}}_{{k}^{′} = 1} {D}_{{iuk}^{′}} , ∀ i , u , 2 \leq ∀ k \leq K , \qquad ( 11 )$$

$${H}_{ik}^{′} \leq ( \vert H \vert - u + 1 ) {A}_{iu} {γ}_{u} + \vert R \vert ( 1 - {{\sum }^{k - 1}}_{{k}^{′} = 1} {D}_{{iuk}^{′}} ) , ∀ i , u , k , \qquad ( 12 )$$

$${γ}_{\tilde{u}} = 1 , \vert R \vert - K + 1 \leq ∀ \tilde{u} \leq \vert R \vert \qquad ( 13 )$$

Here, in a case where the decision rule rᵤ is a k-th decision rule on the decision list L_{R} with respect to an example xᵢ, H′ᵢₖ is represented as follows: H′ᵢₖ=|H|−u+1. The formulae (10) to (12) use (|H|−u+1)γᵤ instead of πᵤ indicative of a height of the decision rule rᵤ. From this, it is understood that the decision rule rᵤ does not give any influence to H′ᵢₖ not only when Aᵢᵤ=0, i.e., the example xᵢ does not satisfy the condition of the decision rule rᵤ but also when γᵤ=0, i.e., the decision list L_{R} does not include the decision rule rᵤ. The formula (13) is a constraint formula ensuring that the default rule is necessarily included in the decision list L_{R}.

In optimization calculation involving use of the formulae indicated above, the binary vector γ having a size of |R| is used instead of π, which is the integer vector having a size of |R|. This narrows a search space as compared to that in the example illustrated in the third example embodiment that uses π. Further, in the third example embodiment, the formulae (7) and (8) are necessary to represent π. However, in the present example embodiment, these formulae are no longer necessary, and thus it is possible to realize ILP expression only with the formulae (5) and (10) to (13).

### (Flow of Learning Method)

The learning method executed by the information processing apparatus 5 is substantially similar to the learning method shown in FIG. 8. The learning method executed by the information processing apparatus 5 differs from the learning method shown in FIG. 8 mainly in the following points. That is, in the learning method executed by the information processing apparatus 5, the process of S41 is not carried out, the variable which is subjected to setting in S43 and which is subjected to updating in S47 does not include π or δ, and setting of ranking by the rank setting section 502 is carried out in advance of calculation of a prediction result in S44. Further, the learning method executed by the information processing apparatus 5 differs from the learning method illustrated in FIG. 8 also in various formulae for use in determining a decision list to be output, e.g., the above-indicated formula (9) used instead of the objective function in S45.

### (Flow of Prediction Method)

The prediction method executed by the information processing apparatus 5 is similar to the prediction method shown in FIG. 2. Specifically, first, the input data acquiring section 505 acquires input data to be subjected to prediction (S21). Subsequently, the prediction section 503 calculates predicted values of, among decision rules included in the decision list 514, K top-ranked decision rules whose conditions are satisfied by the input data acquired in S21, and uses the predicted values to calculate a prediction result.

### Reference Example

The foregoing example embodiments have dealt with the case where the parameter K indicative of the number of decision rules for use in calculation of a final prediction result is not less than 2. However, by employing a configuration of ranking the decision rules included in the decision rule set, the method for reducing the time required for the process of determining a decision list to be output is also effective to a case where the parameter K is 1.

The description of the present reference example will discuss an information processing apparatus 6 that outputs an optimal decision list when the parameter K is a value of not less than 1. FIG. 10 is a block diagram illustrating a configuration of the information processing apparatus 6 according to the present reference example. As shown in FIG. 10, the information processing apparatus 6 includes a rank setting section 61, a prediction section 62, and a list determining section 63.

Similarly to the rank setting section 502 described earlier, the rank setting section 61 ranks decision rules included in a decision rule set.

The prediction section 62 calculates a prediction result on the basis of a predicted value(s) of, among decision rules included in a decision list composed of the decision rules extracted from the decision rule set, one or more decision rules whose condition(s) is/are satisfied by a training example included in a training example set. Thus, in the present reference example, the number of decision rules whose conditions are satisfied may be one. This is because that a case where a parameter K is a value of not less than 1 is assumed.

Note that the process carried out when the parameter K is a value of not less than 2 is similar to that in the fourth example embodiment. Thus, the following description will deal with a case where the parameter K is 1. In this case, the prediction section 62 calculates a prediction result on the basis of a predicted value of, among decision rules included in a decision list composed of the decision rules extracted from a decision rule set, the first decision rule (i.e., a decision rule located at the topmost in the order of the decision rules whose conditions are satisfied) whose condition is satisfied by a training example included in a training example set.

The list determining section 63 determines, from among a plurality of decision lists generated from the decision rule set, a decision list to be output, on the basis of (i) a prediction result calculated for training examples included in the training example set and (ii) the rank set by the rank setting section 61.

As described above, the information processing apparatus 6 includes: the prediction section 62 that calculates a prediction result on the basis of a predicted value of, among decision rules included in a decision list composed of the decision rules extracted from a decision rule set that is a set of decision rules each of which is a combination of a condition and a predicted value for a case where the condition is satisfied, a first decision rule whose condition is satisfied by one of training examples included in a training example set; the rank setting section 61 that ranks the decision rules included in the decision rule set; and the list determining section 63 that determines, from among the decision lists generated from the decision rule set, a decision list to be output, the determining being made on the basis of (i) the prediction result calculated for the training examples included in the training example set and (ii) the rank.

The above configuration ranks the decision rules and calculates a prediction result on the basis of the predicted value of the first decision rule whose condition is satisfied by the training example. This eliminates the need to consider, in determining a decision list to be output, the order of arrangement of the decision rules in the decision list. Thus, the above configuration brings about an effect of making it possible to complete, in a shorter time, the process of determining the decision list to be output, as compared to a case where the process is carried out in consideration of the order of arrangement.

The learning method executed by the information processing apparatus 6 is identical to the learning method of the fourth example embodiment, except that K=1 in the learning method executed by the information processing apparatus 6.

The information processing apparatus 6 may further include an input data acquiring section 21 (see FIG. 1). In this case, the input data acquiring section 21 acquires input data. Then, the prediction section 62 calculates a prediction result with use of a predicted value of, among the decision rules included in the decision list output by the list determining section 63, a decision rule which is located at the topmost location in the order and whose condition is satisfied by the input data acquired by the input data acquiring section 21.

### [Variation]

The processes described in the foregoing example embodiments and reference examples may be carried out by any entity, which is not limited to the foregoing examples. That is, an information processing system including functions similar to the functions of the information processing apparatuses 1 to 6 can be constructed by a plurality of apparatuses that can communicate with each other.

### [Software Implementation Example]

Some or all of functions of the information processing apparatuses 1 to 6 can be realized by hardware such as an integrated circuit (IC chip) or the like or can be alternatively realized by software.

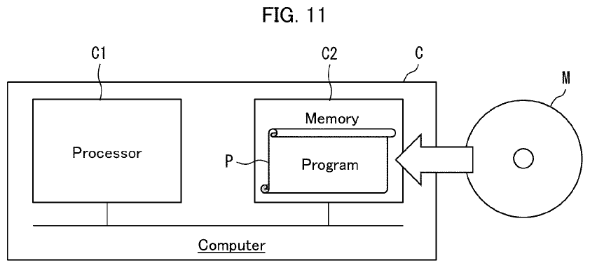

In the latter case, the information processing apparatuses 1 to 6 are each realized by, for example, a computer that executes instructions of a program that is software realizing the functions. FIG. 11 illustrates an example of such a computer (hereinafter referred to as “computer C”). The computer C includes at least one processor C1 and at least one memory C2. The at least one memory C2 stores therein a program P for causing the computer C to operate as each of the information processing apparatuses 1 to 6. In the computer C, the functions of the information processing apparatuses 1 to 6 are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communications network, a broadcast wave, or the like. The computer C can acquire the program P also via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

An information processing apparatus including: a prediction means that calculates a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and a list determining means that determines, from among a plurality of the decision lists generated from the decision rule set, a decision list to be output, the determining being made on a basis of a prediction result calculated for the training examples included in the training example set. This configuration makes it possible to improve prediction performance in prediction carried out with use of a decision list.

### (Supplementary Note 2)

The information processing apparatus described in Supplementary Note 1, wherein: the prediction means calculates, with use of the decision list represented by a variable indicative of a position in the decision list at which position a decision rule included in the decision rule set is located, a value of an objective function including an error term indicative of an error of the prediction result; and the list determining means determines the decision list to be output by repeatedly carrying out a process of updating the variable on a basis of the calculated value of the objective function until the value of the objective function satisfies a predetermined condition. This configuration makes it possible to determine, by optimization calculation involving use of the objective function, the decision list to be output.

### (Supplementary Note 3)

The information processing apparatus described in Supplementary Note 2, wherein: the prediction means calculates the value of the objective function including (i) a constraint term relating to the number of decision rules included in the decision list or (ii) a constraint term relating to the number of conditions included in the decision rules included in the decision list. The above configuration makes it possible to determine a decision list in which a constraint is the number of decision rules included in the decision list or the number of conditions included in the decision rules included in the decision list.

### (Supplementary Note 4)

The information processing apparatus described in Supplementary Note 2 or 3, wherein: the variable includes, for each of the training examples included in the training example set, variables indicative of the K decision rules which are a first to K-th decision rules in the decision list and whose conditions are satisfied by one of the training examples. This configuration makes it possible to determine, by optimization calculation involving use of the objective function, the decision list to be output.

### (Supplementary Note 5)

The information processing apparatus described in any one of Supplementary Notes 1 to 4, further including: an acceptance means that accepts setting of a value of the K, wherein the prediction means calculates the prediction result with use of the value of the K, the value having been accepted by the acceptance means. This configuration enables a user who sets a value of K at a desired value to determine a decision list suitable to calculate a prediction result with use of the value of K.

### (Supplementary Note 6)

The information processing apparatus described in any one of Supplementary Notes 1 to 5, further including: a decision rule set generating means that (a) generates a decision rule by extracting, from at least one decision tree included in a decision tree set including the at least one decision tree, each condition appearing on a path from a root to a leaf of the at least one decision tree and (b) generates the decision rule set including the generated decision rule. This configuration makes it possible to automatically generate a decision rule set on the basis of a decision tree.

### (Supplementary Note 7)

The information processing apparatus described in any one of Supplementary Notes 1 to 3, further including: a rank setting means that ranks the decision rules included in the decision rule set, wherein the prediction means calculates the prediction result with use of the K top-ranked predicted values. This configuration makes it possible to complete, in a shorter time, the process of determining the decision list to be output, as compared to a case where the process is carried out in consideration of the order of arrangement.

### (Supplementary Note 8)

The information processing apparatus described in Supplementary Note 7, wherein: the rank setting means ranks the decision rules on a basis of differences between the predicted values for the training examples satisfying conditions of the decision rules and a predicted value to be compared. This configuration makes it possible to rank the decision rules in descending order of the possibility of calculating a more appropriate predicted value.

### (Supplementary Note 9)

An information processing apparatus including: an input data acquiring means that acquires input data to be subjected to prediction; and a prediction means that calculates a prediction result with use of predicted values of, among decision rules included in a decision list composed of the decision rules each of which is a combination of a condition and a predicted value for a case where the condition is satisfied, K (K is a natural number of not less than 2) top-ranked decision rules whose conditions are satisfied by the input data. This configuration makes it possible to improve prediction performance, as compared to the conventional methods that use only a predicted value of a rule located at the topmost of a decision rule.

### (Supplementary Note 10)

A learning method including: (a) calculating a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and (b) determining, from among a plurality of the decision lists generated from the decision rule set, a decision list to be output, the determining being made on a basis of a prediction result calculated for the training examples included in the training example set, (a) and (b) being carried out by at least one processor. This configuration makes it possible to improve prediction performance in prediction carried out with use of a decision list.

### (Supplementary Note 10)

A learning program for causing a computer to function as: a prediction means that calculates a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and a list determining means that determines, from among a plurality of the decision lists generated from the decision rule set, a decision list to be output, the determining being made on a basis of a prediction result calculated for the training examples included in the training example set. This configuration makes it possible to improve prediction performance in prediction carried out with use of a decision list.

### [Additional Remark 3]

Further, some or all of the above embodiments can be expressed as below. An information processing apparatus including at least one processor, the at least one processor executing: a prediction process of calculating a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and a list determining process of determining, from among a plurality of the decision lists generated from the decision rule set, a decision list to be output, the determining being made on a basis of a prediction result calculated for the training examples included in the training example set.

An information processing apparatus including at least one processor, the at least one processor executing: an input data acquiring means of acquiring input data to be subjected to prediction; and a prediction process of calculating a prediction result with use of predicted values of, among decision rules included in a decision list composed of the decision rules each of which is a combination of a condition and a predicted value for a case where the condition is satisfied, K (K is a natural number of not less than 2) top-ranked decision rules whose conditions are satisfied by the input data.

Note that these information processing apparatuses each may further include a memory, which may store a learning program for causing the at least one processor to execute the prediction process and the list determining process or a prediction program for causing the at least one processor to execute the data acquiring process and the prediction process. These programs may be stored in a non-transitory tangible computer-readable storage medium.

### REFERENCE SIGNS LIST

1 information processing apparatus
11 prediction section
12 list determining section
2 information processing apparatus
21 input data acquiring section
22 prediction section
3 information processing apparatus
302 prediction section
303 list determining section
311 decision rule set
312 training example set
313 decision list
4 information processing apparatus
401 acceptance section
402 decision rule set generating section
403 prediction section
404 list determining section
405 input data acquiring section
411 decision tree set
412 decision rule set
413 training example set
414 decision list
5 information processing apparatus
501 acceptance section
502 rank setting section
503 prediction section
504 list determining section
505 input data acquiring section
512 decision rule set
513 training example set
514 decision list

What is claimed is:

1. An information processing apparatus including at least one processor, the at least one processor executing:
a prediction process of calculating a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and
a list determining process of determining, from among a plurality of the decision lists generated from the decision rule set, a decision list to be output, the determining being made on a basis of a prediction result calculated for the training examples included in the training example set.

2. The information processing apparatus according to claim 1, wherein:
the prediction process calculates, with use of the decision list represented by a variable indicative of a position in the decision list at which position a decision rule included in the decision rule set is located, a value of an objective function including an error term indicative of an error of the prediction result; and
the list determining process determines the decision list to be output by repeatedly carrying out a process of updating the variable on a basis of the calculated value of the objective function until the value of the objective function satisfies a predetermined condition.

3. The information processing apparatus according to claim 2, wherein:
the prediction process calculates the value of the objective function including (i) a constraint term relating to the number of decision rules included in the decision list or (ii) a constraint term relating to the number of conditions included in the decision rules included in the decision list.

4. The information processing apparatus according to claim 2, wherein:
the variable includes, for each of the training examples included in the training example set, variables indicative of the K decision rules which are a first to K-th decision rules in the decision list and whose conditions are satisfied by one of the training examples.

5. The information processing apparatus according to claim 1, the at least one processor further executing:
an acceptance process of accepting setting of a value of the K, wherein
the prediction process calculates the prediction result with use of the value of the K, the value having been accepted by the acceptance process.

6. The information processing apparatus according to claim 1, the at least one processor further executing:
a decision rule set generating process of (a) generating a decision rule by extracting, from at least one decision tree included in a decision tree set including the at least one decision tree, each condition appearing on a path from a root to a leaf of the at least one decision tree and (b) generating the decision rule set including the generated decision rule.

7. The information processing apparatus according to claim 1, the at least one processor further executing:
a rank setting process of ranking the decision rules included in the decision rule set, wherein
the prediction process calculates the prediction result with use of the K top-ranked predicted values.

8. The information processing apparatus according to claim 7, wherein:
the rank setting process ranks the decision rules on a basis of differences between the predicted values for the training examples satisfying conditions of the decision rules and a predicted value to be compared.

9. An information processing apparatus including at least one processor, the at least one processor executing:
an input data acquiring process of acquiring input data to be subjected to prediction; and
a prediction process of calculating a prediction result with use of predicted values of, among decision rules included in a decision list composed of the decision rules each of which is a combination of a condition and a predicted value for a case where the condition is satisfied, K (K is a natural number of not less than 2) top-ranked decision rules whose conditions are satisfied by the input data.

10. A learning method comprising:
(a) calculating a prediction result with use of predicted values of, among decision rules included in a decision list composed of the decision rules extracted from a decision rule set that is a set of decision rules each of which is a combination of a condition and a predicted value for a case where the condition is satisfied, K (K is a natural number of not less than 2) top-ranked decision rules whose conditions are satisfied by one of training examples included in a training example set; and
(b) determining, from among a plurality of the decision lists generated from the decision rule set, a decision list to be output, the determining being made on a basis of a prediction result calculated for the training examples included in the training example set,
(a) and (b) being carried out by at least one processor.

11. A non-transitory recording medium having a learning program stored therein, the learning program causing a computer to function as the information processing apparatus according to claim 1, the learning program causing the computer to execute the prediction process and the list determining process.
